(19) United States
(12) Patent Application Publication
(10) Pub. No.: US 2015/0251507 A1
(43) Pub. Date: Sep. 10, 2015

(54) VERTICAL HITCH ADJUSTMENT

(71) Applicant: Power Pin Inc., Fort Qu'Appelle (CA)

(72) Inventor: Brian R. Olson, Fort Qu'Appelle (CA)

(21) Appl. No.: 14/635,392

(22) Filed: Mar. 2, 2015

(30) Foreign Application Priority Data
Mar. 7, 2014 (CA) 2844953

(51) Int. Cl. B60D 1/46; B60D 1/06

(52) U.S. Cl. CPC B60D 1/46; B60D 1/06

(57) ABSTRACT

A vertically adjustable hitch apparatus has a base with a base plate and vehicle mount adapted to be attached to a vehicle such that the base plate is oriented substantially vertically on a side of the base opposite the vehicle with a vehicle face of the base plate facing the vehicle. A hitch member has a hitch plate attached to the base plate such that an engagement portion of the hitch member extends away from the base plate. The hitch plate is attached to the base plate by a plurality of bolts extending through bolt holes in one of the hitch plate and the base plate, and through vertically oriented slots in the other of the hitch plate and the base plate.

This disclosure relates to the field of hitches for connecting a towed vehicle to a towing vehicle and in particular a hitch apparatus that facilitates vertical adjustment.

### BACKGROUND

Hitch mechanisms for towed vehicles take a variety of forms, such as clevis and tongue mechanisms, ball and socket mechanisms, pintle hook and ring mechanisms, and the like. Clevis and tongue mechanism are generally used on larger slow moving equipment such as for connecting an agricultural implement to a tractor drawbar, while vehicles for road travel typically use a ball and socket or a pintle hook and ring. Such mechanisms comprise two separate hitch members, with a first hitch member attached to the towing vehicle and a second hitch member attached to the towed vehicle, with engaging portions of each hitch member configured to engage each other to connect the vehicles.

A typical towed vehicle comprises a forward extending tongue and the towed vehicle is configured such that there is weight on the tongue that is supported by a jack when parked, and by the towed vehicle when connected. When connecting the vehicles the towed vehicle is typically reversed to bring the hitch member attached to the rear end thereof into alignment under the towed vehicle hitch member, and then the towed vehicle hitch member is lowered onto the towing vehicle hitch member. Thus the towing vehicle hitch member is typically provided by a ball or pintle hook onto which the socket or ring of the towed vehicle is lowered and supported.

It is common for a single towed vehicle to be regularly connected to a variety of different towing vehicles, and similarly a towing vehicle is often connected to a variety of different towed vehicles. While it is commonly desirable to connect the towed and towing vehicles such that the towed vehicle is level, to accomplish this often requires adjustment of the vertical position of at least one of the hitch members.

It is common to attach the hitch member to the vehicle with bolts, and commonly a plurality of bolt holes will be provided to allow the bolts to be removed, the hitch member relocated to a different desired vertical position, and then the bolts re-inserted and tightened to secure the hitch member in the desired vertical position.

Vertically adjustable hitch mechanisms using a plurality of vertically spaced holes and pins and like fasteners are disclosed in U.S. Pat. No. 7,451,996 to Miles et al. and U.S. Pat. No. 8,356,831 to Pollock et al (with scissor extension), and in United States Published Patent Application Number 2010/0127479 of Weipert et al.

U.S. Pat. No. 8,408,577 to Works discloses a hitch member base with vertically spaced ridges where the hitch member is secured at a selected one of the ridges.

U.S. Pat. No. 6,663,133 to Rosenlund has a screw operative to raise and lower the hitch member. U.S. Pat. No. 3,554,578 to Reed uses a motorized screw to remotely raise and lower the hitch member from the towing vehicle. U.S. Pat. No. 3,236,541 to Poteet uses a screw to raise and lower the hitch member and a set screw moves up and down in a slot. Vibration during transport could cause the screw to turn such that the hitch member could move vertically and so the set screw is tightened to prevent accidental movement of the hitch member during transport.

Although more commonly the towed vehicle hitch member is lowered onto the towing vehicle hitch member to engage the hitch members and connect the vehicles, the screw mechanisms above can be used to instead raise the towing vehicle hitch member upward into engagement with the towed vehicle hitch member.

### SUMMARY OF THE INVENTION

The present disclosure provides a hitch apparatus with vertical adjustment that overcomes problems in the prior art.

In a first embodiment the present disclosure provides a vertically adjustable hitch apparatus comprising a base comprising a vehicle mount and a base plate, the vehicle mount adapted to be attached to a vehicle such that the base plate is oriented substantially vertically on a side of the base opposite the vehicle with a vehicle face of the base plate facing the vehicle. A hitch member comprises a hitch plate attached to the base plate such that an engagement portion of the hitch member extends away from the base plate. The hitch plate is attached to the base plate by a plurality of bolts extending through bolt holes in one of the hitch plate and the base plate, and through vertically oriented slots in the other of the hitch plate and the base plate.

In a second embodiment the present disclosure provides a vertically adjustable hitch apparatus comprising a base comprising a vehicle mount and a base plate, the vehicle mount adapted to be attached to a vehicle such that the base plate is oriented substantially vertically on a side of the base opposite the vehicle with a vehicle face of the base plate facing the vehicle. A hitch member comprises a hitch plate attached to the base plate such that an engagement portion of the hitch member extends away from the base plate. The base plate defines right and left slots oriented, when the base is attached to the vehicle, substantially vertically, and the hitch plate defines right upper and lower bolt holes and left upper and lower bolt holes. The hitch plate is attached to the base plate by bolts extending through the slots and the bolt holes such that heads of the bolts are adjacent to the vehicle face of the base plate, and nuts threaded onto shanks of the bolts bear against the hitch plate. The shanks of the bolts are configured to prevent the bolts from rotating when the nuts are threaded onto the shanks.

The vertically adjustable hitch apparatus of the present disclosure is economical to produce and provides simple adjustment of the vertical position of the engagement portion of the hitch member, and the vertical range of movement can be varied to suit the particular application. The slotted plate allows the vertical position of the hitch member to be adjusted without removing the bolts, greatly simplifying the operation and reducing the time required to make the adjustment. Using carriage bolts facilitates loosening and re-tightening the hitch member. Washer plates can be provided to increase the area on which the clamping force is exerted, thereby reducing the risk of slippage of the plates with respect to each other.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic rear view of a base for use with embodiment of a vertically adjustable hitch apparatus of the present disclosure schematically illustrated in FIGS. 6 and 7;

FIG. 2 is a side view of the base of FIG. 1, also showing a carriage bolt and nut;

FIG. 3 is an end view of the carriage bolt of FIG. 2;

FIG. 4 is a schematic side view of a hitch member for use with the embodiment of a vertically adjustable hitch apparatus of the present disclosure schematically illustrated in FIGS. 6 and 7;

FIG. 5 is a schematic front view of the hitch member of FIG. 4;

FIG. 6 is a schematic front view of an embodiment of a vertically adjustable hitch apparatus of the present disclosure;

FIG. 7 is a schematic side view of the embodiment of FIG. 6;

FIG. 8 is a front view of a right or left washer plate for use with the embodiment of FIGS. 6 and 7;

FIG. 9 is a front view of an alternate full width washer plate for use with the embodiment of FIGS. 6 and 7.

### DETAILED DESCRIPTION OF THE ILLUSTRATED EMBODIMENTS

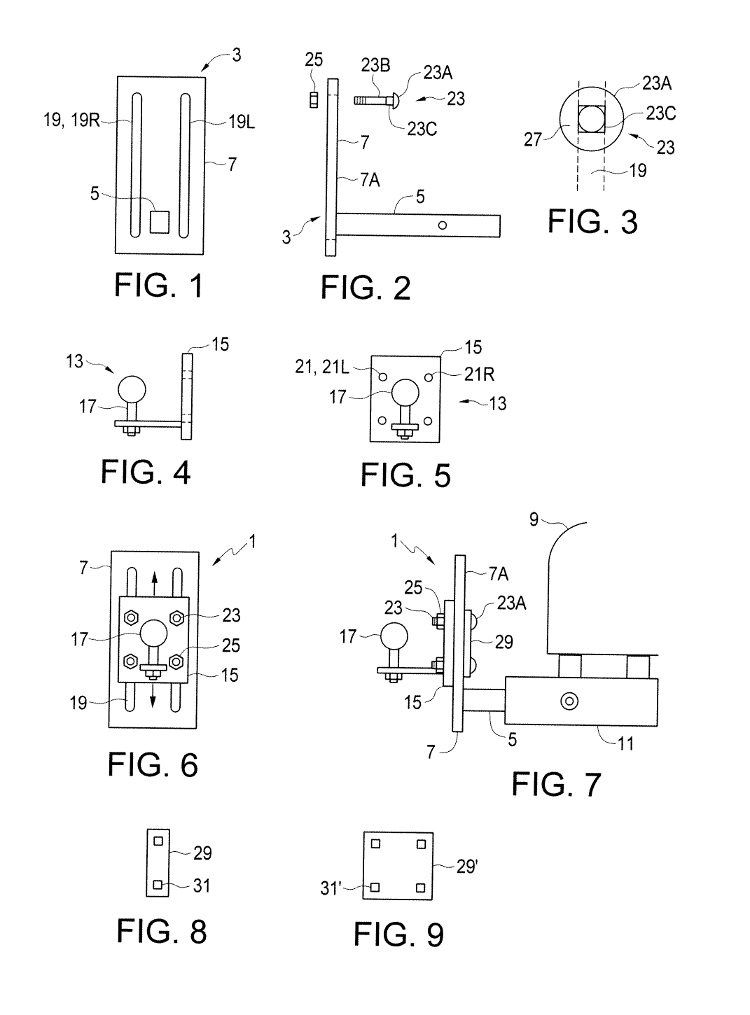

FIGS. 1-8 schematically illustrate various parts and completed assemblies of an embodiment of a vertically adjustable hitch apparatus 1 of the present disclosure. The apparatus 1 comprises a base 3 comprising a vehicle mount 5 and a base plate 7. The vehicle mount 5 is adapted to be attached to a vehicle 9 such that the base plate is oriented substantially vertically on a side of the base 3 opposite the vehicle with a vehicle face 7A of the base plate 7 facing the vehicle 9.

In the illustrated apparatus 1, the vehicle mount 5 is schematically illustrated as a bar welded to the base plate 7, and configured to be inserted into a tube 11 attached to the vehicle 9 as schematically illustrated in FIG. 7, and as is well known in the art. It is well known to mount hitches to vehicles using bolts, welding, and the like, and the vehicle mount 5 of the base 3 could be provided by like methods as well.

A hitch member 13 comprises a hitch plate 15 attached to the base plate 7 such that an engagement portion of the hitch member, illustrated as a trailer ball 17, extends away from the base plate 7 as shown in FIG. 7. The engagement portion of the hitch member could also be a pintle hook, trailer ball socket, pintle ring, or like hitch member as known in the art and the vehicle could be either the towed or the towing vehicle, since vertical adjustment of either will accomplish the purpose of vertical alignment of the hitch portions on the towed and towing vehicles.

The base plate 7 defines right and left slots 19R, 19L oriented, when the base 3 is attached to the vehicle 9, substantially vertically. Correspondingly, the hitch plate 15 defines right upper and lower bolt holes 21R and left upper and lower bolt holes 21L. As schematically illustrated in FIGS. 6 and 7 the hitch plate 15 is attached to the base plate 7 by bolts 23 extending through the slots 19 and the bolt holes 21 such that heads 23A of the bolts 23 are adjacent to the vehicle face 7A of the base plate 7, and nuts 25 threaded onto shanks 23B of the bolts 23 and bearing against the hitch plate 15.

To adjust the vertical position of the trailer ball 17 with respect to the vehicle 9, the nuts 25 are loosened and the hitch plate 15 is moved up or down as indicated by the arrows in FIG. 6, with the bolts 23 moving in the slots 19, to a desired position and then the bolts are re-tightened to clamp the hitch plate 15 to the base plate 7 in a fixed position.

The shanks 23B of the bolts 23 are configured to prevent the bolts 23 from rotating when the nuts 25 are threaded onto the shanks 23B. Thus the operator needs only a single wrench to adjust the vertical position, and does not have to place a wrench on the head of the bolt in the area between the vehicle and the base plate 7 which can be somewhat difficult to access.

In the illustrated apparatus 1, head portions 23C of the shanks 23B of the bolts 23, located adjacent to the heads 23A of the bolts 23, have a rectangular cross-section as seen in FIG. 3. Such bolts 23 are commonly known in the art as carriage bolts, and are inserted into rectangular holes so that the rectangular head portions 23C engage the rectangular hole and the shank 23B is prevented from rotating.

As schematically illustrated in FIG. 2, the bolts 23 can be simply inserted from the vehicle side of the base plate 7 so that the rectangular head portions 23C engage the sides of the slots 19, shown in phantom lines in FIG. 3, and the shanks 23B are thus prevented from rotating when the nuts 25 are threaded onto the shanks 23B. Side edge portions 27 of the bolt heads 23A then bear against the vehicle face of the base plate and provide the required clamping force when the nuts are tightened.

FIG. 7 illustrates the apparatus 1 with the addition of right and left washer plates 29 between the heads 23A of the bolts 23 and the vehicle face 7A of the base plate 7 on each of the right and left sides of the base plate 7. Each washer plate 29 defines a pair of rectangular washer holes 31, as shown in FIG. 8, spaced to correspond to a distance between the corresponding right and left upper and lower bolt holes 21. The bolts 23 here are inserted through the washer holes 31, slots 19, and bolt holes 21 such that the heads 23A of the bolts 23 bear against the washer plates 29 and the washer plates 29 bear against the vehicle face 7A of the base plate 7 and nuts 25 threaded onto the shanks 23B bear against the hitch plate 15. The rectangular head portions 23C of the shanks 23B of the bolts 23 engage the rectangular washer holes 31. Since there are upper and lower bolts 23 extending through each washer plate 29, the washer plates 29 are prevented from rotating and thus prevent the bolts 23 from rotating when the nuts 25 are threaded onto the shanks.

Using the washer plates 29 increases the area on which the clamping force is exerted. The whole surface of the heads 23A bears against the washer plate 29, rather than only the portion 27 shown in FIG. 3 where the rectangular head portions 23C of the shanks 23B of the bolts 23 engage sides of the slots 19, and then the whole area of the washer plate 29 bears against the vehicle face 7A of the base plate 7.

FIG. 9 schematically illustrates and alternate full width washer plate 29′. Similar to the right and left washer plates 29 described above, upper and lower right bolts extend through rectangular washer holes 31′ defined in a right side of the washer plate and upper and lower left bolts extend through rectangular washer holes 31′ defined in a left side of the washer plate. The four rectangular washer holes 31′ correspond to the holes 21 in the hitch plate 15. Although somewhat limiting the vertical adjustment range because of interference with the vehicle mount 5, in some heavy applications, such as agricultural implements, the full width washer plate 29′ may provide sufficient increased clamping forces against the entire face of the base plate 7 to warrant its use.

The vehicle mount 5 of the base 3 is located in proximity to one end of the slots 19, and is configured so that same can slide into the tube 11 with the slots 19 extending upward from the vehicle mount 5 of the base and also can be rotated 180 degrees and slide into the tube 11 such that the slots 19 extend downward from the vehicle mount 5 of the base 3. Since the hitch plate is symmetrical, if the base 3 is rotated 180 degrees, the bolts 23 can be removed and reinstalled with the trailer ball extending upward as required. Thus the vertical range of movement of the trailer ball 17 can be increased by rotating the vehicle mount 5 in the tube 11.

Also while the illustrated apparatus 1 shows the slots defined in the base 3 that mounts to the vehicle 9, it is contemplated that the slots could be provided in the hitch plate 15 and the holes 21 could be provided in the base plate 7. It is contemplated as well that conventional hitch members of various configurations could be modified to provide holes aligned with slots and so be used in the present apparatus. It is also contemplated that the vehicle 9 to which the apparatus 1 is attached could be a towed vehicle or a towing vehicle.

The vertically adjustable hitch apparatus 1 of the present disclosure is economical to produce and provides simple adjustment of the vertical position of the engagement portion of the hitch member, such as the illustrated trailer ball 17, through a significant vertical range. The operator needs only to loosen the nuts 25 with a single wrench and slide the hitch plate 15 up or down to the desired position, and at most may need to reach into the confined space between the base 3 and the vehicle 9 with a finger to reposition an over-loosened bolt 23 back into engagement with the washer plate 29 or slot 19 to prevent rotation. The washer plates 29 ensure sufficient clamping forces on the hitch plate 15 and base plate 7 to prevent slippage of the hitch plate 15 with respect to the base plate 7.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A vertically adjustable hitch apparatus comprising:
a base comprising a vehicle mount and a base plate, the vehicle mount adapted to be attached to a vehicle such that the base plate is oriented substantially vertically on a side of the base opposite the vehicle with a vehicle face of the base plate facing the vehicle;
a hitch member comprising a hitch plate attached to the base plate such that an engagement portion of the hitch member extends away from the base plate;
wherein the hitch plate is attached to the base plate by a plurality of bolts extending through bolt holes in one of the hitch plate and the base plate, and through vertically oriented slots in the other of the hitch plate and the base plate.

2. The apparatus of claim 1 wherein the slots are defined in the base plate and the bolt holes are defined in the hitch plate.

3. The apparatus of claim 2 wherein the bolts are inserted through the slots and bolt holes such that heads of the bolts are adjacent to the vehicle face of the base plate and shanks of the bolts extend through the slots in the base plate and the bolt holes in the hitch plate, and nuts are threaded onto the shanks and bear against the hitch plate, and wherein the shanks of the bolts are configured to prevent the bolts from rotating when the nuts are threaded onto the shanks.

4. The apparatus of claim 3 wherein head portions of the shanks of the bolts located adjacent to the heads of the bolts have a rectangular cross-section configured to engage the slots to prevent the bolts from rotating when the nuts are threaded onto the shanks.

5. The apparatus of claim 3 wherein the hitch plate defines upper and lower bolt holes aligned with one of the slots, and comprising a washer plate defining a pair of rectangular washer holes spaced to correspond to a distance between the upper and lower bolt holes, wherein the bolts are inserted through the washer holes, slots, and bolt holes such that the heads of the bolts bear against the washer plate and the washer plate bears against the vehicle face of the base plate and nuts threaded onto the shanks bear against the hitch plate, and head portions of the shanks of the bolts located adjacent to the heads of the bolts have a rectangular cross-section configured to engage the washer holes to prevent the bolts from rotating when the nuts are threaded onto the shanks.

6. The apparatus of claim 5 wherein right and left slots are defined in the base plate and upper and lower bolt holes are defined in corresponding right and left sides of the hitch plate and wherein upper and lower right bolts extend through rectangular washer holes defined in a right washer plate, through the right slot and through upper and lower right bolt holes, and upper and lower left bolts extend through rectangular washer holes defined in a left washer plate, through the left slot and through upper and lower left bolt holes.

7. The apparatus of claim 5 wherein right and left slots are defined in the base plate and upper and lower bolt holes are defined in corresponding right and left sides of the hitch plate and wherein upper and lower right bolts extend through rectangular washer holes defined in a right side of the washer plate and upper and lower left bolts extend through rectangular washer holes defined in a left side of the washer plate.

8. The apparatus of claim 2 the vehicle mount of the base is located in proximity to a first end of the slots, and wherein the vehicle mount is adapted to be attached to the vehicle such that the slots extend upward from the vehicle mount of the base and is further adapted to be attached to the vehicle such that the slots extend downward from the vehicle mount of the base.

9. A vertically adjustable hitch apparatus comprising:
a base comprising a vehicle mount and a base plate, the vehicle mount adapted to be attached to a vehicle such that the base plate is oriented substantially vertically on a side of the base opposite the vehicle with a vehicle face of the base plate facing the vehicle;
a hitch member comprising a hitch plate attached to the base plate such that an engagement portion of the hitch member extends away from the base plate;
wherein the base plate defines right and left slots oriented, when the base is attached to the vehicle, substantially vertically;
wherein the hitch plate defines right upper and lower bolt holes and left upper and lower bolt holes;
wherein the hitch plate is attached to the base plate by bolts extending through the slots and the bolt holes such that heads of the bolts are adjacent to the vehicle face of the base plate, and nuts threaded onto shanks of the bolts bear against the hitch plate; and
wherein the shanks of the bolts are configured to prevent the bolts from rotating when the nuts are threaded onto the shanks.

10. The apparatus of claim 9 wherein head portions of the shanks of the bolts located adjacent to the heads of the bolts have a rectangular cross-section configured to engage the slots to prevent the bolts from rotating when the nuts are threaded onto the shanks.

11. The apparatus of claim 9 comprising right and left washer plates, each washer plate defining a pair of rectangular washer holes spaced to correspond to a distance between the corresponding right and left upper and lower bolt holes, wherein the bolts are inserted through the washer holes, slots, and bolt holes such that the heads of the bolts bear against the washer plates and the washer plates bear against the vehicle face of the base plate and nuts threaded onto the shanks bear against the hitch plate, and head portions of the shanks of the bolts located adjacent to the heads of the bolts have a rectangular cross-section configured to engage the washer holes to prevent the bolts from rotating when the nuts are threaded onto the shanks.

12. The apparatus of claim 9 comprising a washer plate defining rectangular washer holes spaced to correspond to the right and left upper and lower bolt holes, wherein the bolts are inserted through the washer holes, slots, and bolt holes such that the heads of the bolts bear against the washer plate and the washer plate bears against the vehicle face of the base plate and nuts threaded onto the shanks bear against the hitch plate, and head portions of the shanks of the bolts located adjacent to the heads of the bolts have a rectangular cross-section configured to engage the washer holes to prevent the bolts from rotating when the nuts are threaded onto the shanks.

13. The apparatus of claim 9 wherein the vehicle mount of the base is located in proximity to a first end of the slots, and wherein the vehicle mount is adapted to be attached to the vehicle such that the slots extend upward from the vehicle mount of the base and is further adapted to be attached to the vehicle such that the slots extend downward from the vehicle mount of the base.
